(19) United States
(12) Patent Application Publication
(10) Pub. No.: US 2025/0218650 A1
(43) Pub. Date: Jul. 3, 2025

(54) COIL DEVICE AND METHOD OF MANUFACTURING THE SAME

(71) Applicant: TDK CORPORATION, Tokyo (JP)

(72) Inventors: Kosuke ENDO, Tokyo (JP); Shohei ABE, Tokyo (JP); Satoshi SUGIMOTO, Tokyo (JP)

(73) Assignee: TDK CORPORATION, Tokyo (JP)

(21) Appl. No.: 18/978,786

(22) Filed: Dec. 12, 2024

(30) Foreign Application Priority Data
Dec. 28, 2023 (JP) 2023-223624

(51) Int. Cl. H01F 27/28; H01F 27/29; H01F 41/02; H01F 41/10

(52) U.S. Cl. CPC H01F 27/2828; H01F 27/292; H01F 41/0246; H01F 41/10

(57) ABSTRACT

A coil device includes a core and a wire. The core contains a magnetic material and includes a mounting surface and a side surface extending in a direction perpendicular to the mounting surface. The wire includes a winding portion disposed inside the core and a leading portion led out from the winding portion. The leading portion includes a base end portion extending from the winding portion toward the side surface and a flat terminal portion continuing to the base end portion and extending along at least the side surface. The plating layer is formed on the terminal portion. A recess recessed toward the opposite side to the mounting surface is formed in the vicinity of a boundary portion between the base end portion and the terminal portion.

### BACKGROUND OF THE DISCLOSURE

The present invention relates to a coil device and a method of manufacturing the coil device.

For example, Patent Document 1 discloses a coil device that can be used as an inductor. The coil device of Patent Document 1 includes a winding portion disposed inside a core and a terminal portion led out from the winding portion and pressed into a flat shape. A part of the terminal portion is disposed inside the core. A remaining part of the terminal portion is exposed from the core and extends along a side surface and a mounting surface of the core.

In the coil device of Patent Document 1, the terminal portion disposed on the mounting surface can be connected to a mounting board by a conductive bonding material (solder, conductive adhesive, etc.). That is, since the terminal portion functions as a terminal of the coil device, there is no need to provide a separate terminal on the coil device, and the coil device can be downsized and reduced for the number of parts.

Patent Document 1: JP2009123927 (A)

### BRIEF SUMMARY OF THE INVENTION

Meanwhile, a plating layer (solder plating, etc.) is formed on the terminal portion so as to improve adhesion to the bonding material. When the plating layer is formed on the terminal portion, however, the plating layer on the terminal portion may melt due to, for example, the heat of reflow. In this case, the molten plating layer may wet up to the winding portion via the terminal portion, and short-circuit defects may occur.

The present disclosure provides a coil device capable of preventing the occurrence of short-circuit defects and a method of manufacturing the coil device.

A coil device according to the present disclosure comprises:

a core containing a magnetic material and including a mounting surface and a side surface extending in a direction perpendicular to the mounting surface; and

a wire including a winding portion disposed inside the core and a leading portion led out from the winding portion,

wherein

the leading portion includes:
a base end portion extending from the winding portion toward the side surface; and
a flat terminal portion continuing to the base end portion and extending along at least the side surface,

a plating layer is formed on the terminal portion, and

a recess recessed toward the opposite side to the mounting surface is formed in the vicinity of a boundary portion between the base end portion and the terminal portion.

At least a part of the recess may be exposed from the core.

The leading portion may include: an inner surface facing the mounting surface or the side surface; and an outer surface opposed to the inner surface, and the recess may be formed on the inner surface.

The base end portion may include an inclined portion, at least a part of the inclined portion may be exposed from the core, and a thickness of the inclined portion may decrease toward the boundary portion in a cross section perpendicular to the mounting surface and the side surface.

The inclined portion may include an inclined surface inclined oppositely from the mounting surface toward the boundary portion.

The leading portion may include: an inner surface facing the mounting surface or the side surface; and an outer surface opposed to the inner surface, a part of the recess may be formed along the inclined surface, and a remaining part of the recess may be formed along the inner surface of the terminal portion.

The leading portion may include: an inner surface facing the mounting surface or the side surface; and an outer surface opposed to the inner surface, and the plating layer may be formed at least on the inner surface in the recess.

A thickness of the leading portion may be smallest at the recess in a cross section perpendicular to the mounting surface and the side surface.

The terminal portion may include: a side portion extending along the side surface; and a mounting portion extending along the mounting surface.

A method of manufacturing a coil device according to the present disclosure comprises the steps of:

preparing a wire including a winding portion and a leading portion led out from the winding portion;

forming a flat terminal portion and an inclined portion by pressing the leading portion, the inclined portion being having a thickness decreasing from the winding portion toward the terminal portion;

placing the wire in a cavity of a mold and filling the cavity with a core material containing a magnetic material and a resin so that the winding portion is embedded;

forming a core by compressing the core material;

forming a plating layer at least on the terminal portion; and

bending the terminal portion from the inclined portion toward the core in the vicinity of a boundary portion between the inclined portion and the terminal portion.

### BRIEF DESCRIPTION OF THE SEVERAL VIEWS OF THE DRAWING

FIG. 1A is a perspective view of a coil device according to an embodiment of the present disclosure;

FIG. 1B is a perspective view showing an internal configuration of the coil device of FIG. 1A;

FIG. 1C is a bottom view of the coil device shown in FIG. 1A;

FIG. 2 is a perspective view of a wire shown in FIG. 1B;

FIG. 3 is a plan view of the coil device shown in FIG. 1B;

FIG. 4A is a cross-sectional view taken along line IVA-IVA shown in FIG. 3;

FIG. 4B is a cross-sectional view of a modified example of leading portions shown in FIG. 4A;

FIG. 4C is a cross-sectional view of another modified example of leading portions shown in FIG. 4A;

FIG. 4D is a cross-sectional view of a modified example of leading portions shown in FIG. 4C;

FIG. 4E is a cross-sectional view of another modified example of leading portions shown in FIG. 4C;

FIG. 5A is a plan view showing a method of manufacturing the coil device shown in FIG. 1A;

FIG. 5B is a plan view showing a step subsequent to the step shown in FIG. 5A;

FIG. 5C is a plan view showing a step subsequent to the step shown in FIG. 5B; and

FIG. 5D is a plan view showing a step subsequent to the step shown in FIG. 5C.

### DETAILED DESCRIPTION OF THE INVENTION

Hereinafter, an embodiment of the present disclosure is described with reference to the figures. Note that, the contents shown in the figures are merely schematic and illustrative for understanding of the present disclosure, and the appearance, dimensional ratio, etc. may be different from the actual one. The present disclosure is not limited to the following embodiment.

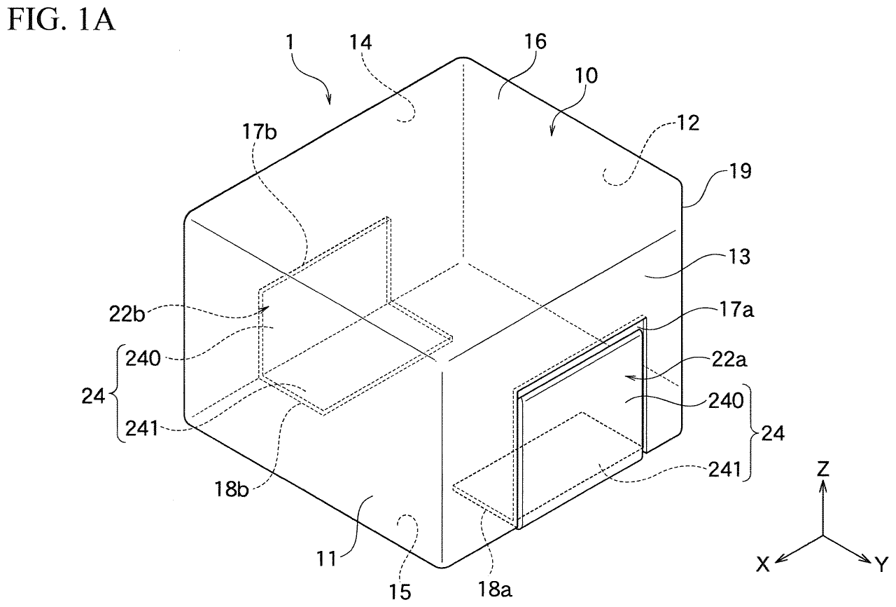

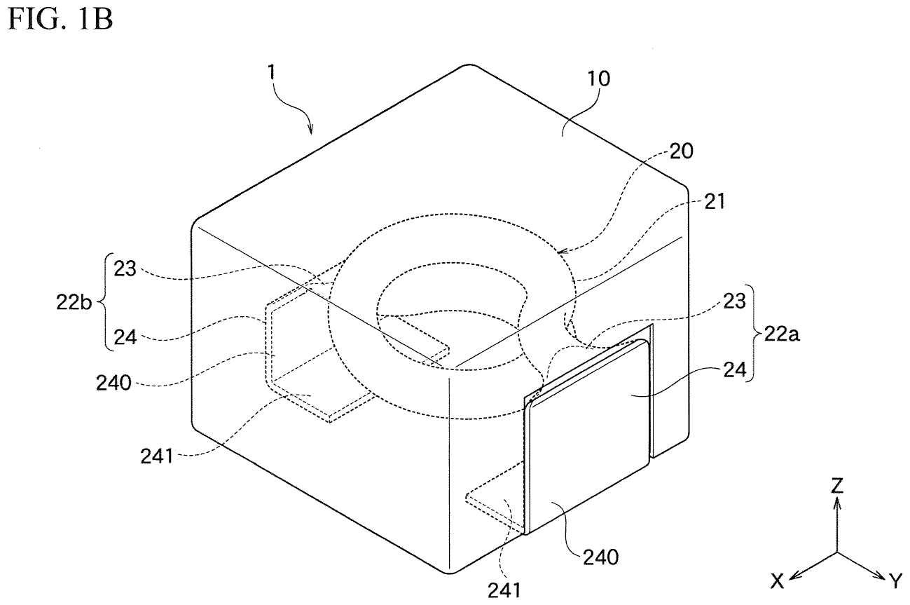

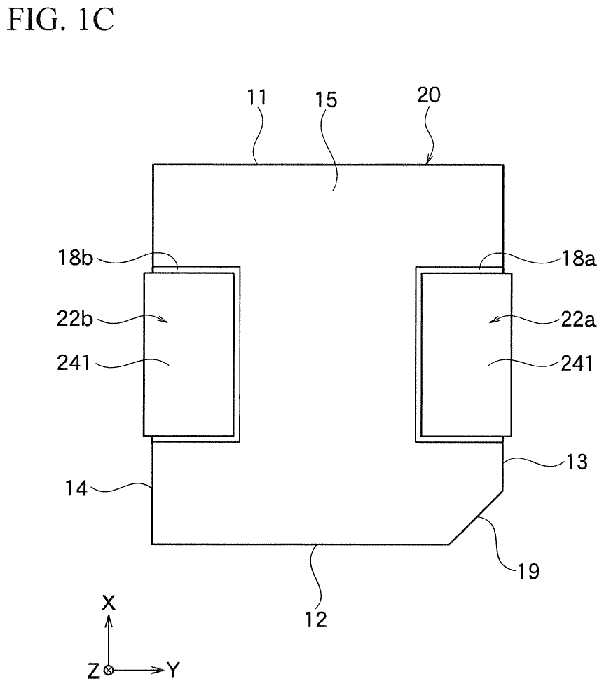

A coil device 1 shown in FIG. 1A is a surface-mounted inductor and is mounted, for example, on a power supply circuit of an electronic device. The coil device 1 includes a core 10 and a wire 20 (FIG. 1B). The shape of the core 10 is not limited and is substantially a hexahedron in the example shown in FIG. 1A. The shape of the core 10 may be a cylinder, an elliptical cylinder, an n-hedron (n≥7), or another polygon. The core 10 includes a first side surface 11, a second side surface 12, a third side surface 13, a fourth side surface 14, a mounting surface 15, and a mounting opposition surface 16.

The ridge between the second side surface 12 and the third side surface 13 is chamfered, and the ridge between the second side surface 12 and the third side surface 13 is formed with a chamfered portion 19. Since the chamfered portion 19 is formed on the core 10, it becomes easier to determine the orientation of the core 10. However, the chamfered portion 19 is not essential and may be omitted.

The first side surface 11 and the second side surface 12 are opposed to each other. The third side surface 13 and the fourth side surface 14 are opposed to each other. The mounting surface 15 and the mounting opposition surface 16 are opposed to each other.

In FIG. 1A, etc., the X-axis is an axis along the direction in which the first side surface 11 and the second side surface 12 are opposed to each other. The Y-axis is an axis along the direction in which the third side surface 13 and the fourth side surface 14 are opposed to each other. The Z-axis is an axis along the direction in which the mounting surface 15 and the mounting opposition surface 16 are opposed to each other (a direction perpendicular to the mounting surface 15).

The X-axis, the Y-axis, and the Z-axis are perpendicular to each other. Hereinafter, for each of the X-axis, the Y-axis, and the Z-axis, the direction away from the center of the core 10 is referred to as “outer side”, and the direction toward the center of the core 10 is referred to as “inner side”. The positive side in the Z-axis is referred to as “upper side”, and the negative side in the Z-axis is referred to as “lower side”. However, the upper side in the Z-axis direction does not necessarily correspond with the upper side in the vertical direction. Also, the lower side in the Z-axis direction does not necessarily correspond with the lower side in the vertical direction.

The width of the core 10 in the X-axis direction is not limited and is, for example, 3.0 to 10.0 mm. The width of the core 10 in the Y-axis direction is not limited and is, for example, 3.0 to 10.0 mm. The width of the core 10 in the Z-axis direction (the thickness of the core 10) is not limited and is, for example, 2.0 to 10.0 mm.

The core 10 is made of a composite material containing a magnetic material and a resin. The method of forming the core 10 is not limited and is, for example, powder compaction, injection molding, or cutting. In the present embodiment, the core 10 is a compact containing a magnetic material and a resin. The magnetic material constituting the core 10 is not limited and is, for example, ferrite (Ni—Zn based ferrite, based Mn—Zn ferrite, etc.) or a metallic magnetic material. The resin constituting the core 10 is not limited and is, for example, an epoxy resin or a phenol resin.

The core 10 includes first recesses 17a and 17b and second recesses 18a and 18b. The first recess 17a and the second recess 18a are formed continuously from the third side surface 13 to the mounting surface 15. The first recess 17b and the second recess 18b are formed continuously from the fourth side surface 14 to the mounting surface 15.

The first recess 17a is formed on the third side surface 13, and the first recess 17b is formed on the fourth side surface 14. A side portion 240 of a leading portion 22a described below is disposed in the first recess 17a, and a side portion 240 of a leading portion 22b described below is disposed in the first recess 17b. The width of the first recess 17a (17b) in the X-axis direction is larger than the width of the side portion 240 in the X-axis direction.

The second recesses 18a and 18b are formed on the mounting surface 15. A mounting portion 241 of the leading portion 22a described below is disposed in the second recess 18a, and a mounting portion 241 of the leading portion 22b described below is disposed in the second recess 18b. The width of the second recess 18a (18b) in the X-axis direction is larger than the width of the mounting portion 241 in the X-axis direction. The depth of the second recess 18a (18b) is equal to or less than the thickness of the mounting portion 241. The first recesses 17a and 17b and the second recesses 18a and 18b are not essential and may be omitted from the core 10.

As shown in FIG. 1B, the wire 20 includes a winding portion 21, a leading portion 22a, and a leading portion 22b. The wire 20 is, for example, an insulating coated wire in which a conductive core wire is coated with an insulating coating (insulating coating layer). The wire 20 can be, for example, a known winding wire such as polyamideimide copper wire (AIW), polyurethane copper wire (UEW), and polyester copper wire (PEW). The material constituting the wire is not limited and is, for example, copper, copper alloy, silver, or nickel. The wire 20 is a round wire, but may be a rectangular wire (e.g., edgewise wound rectangular wire), or the like. The diameter of the wire 20 is not limited and is, for example, 0.3 to 2.0 mm.

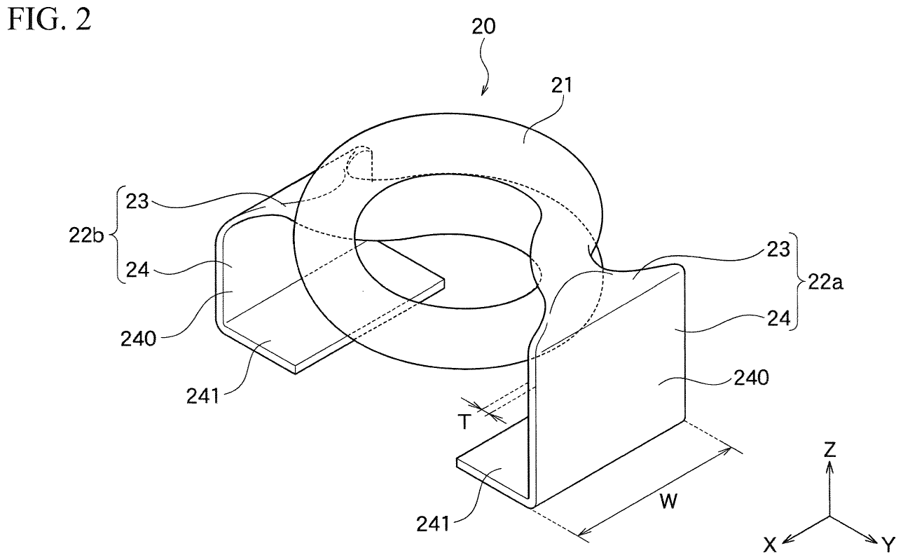

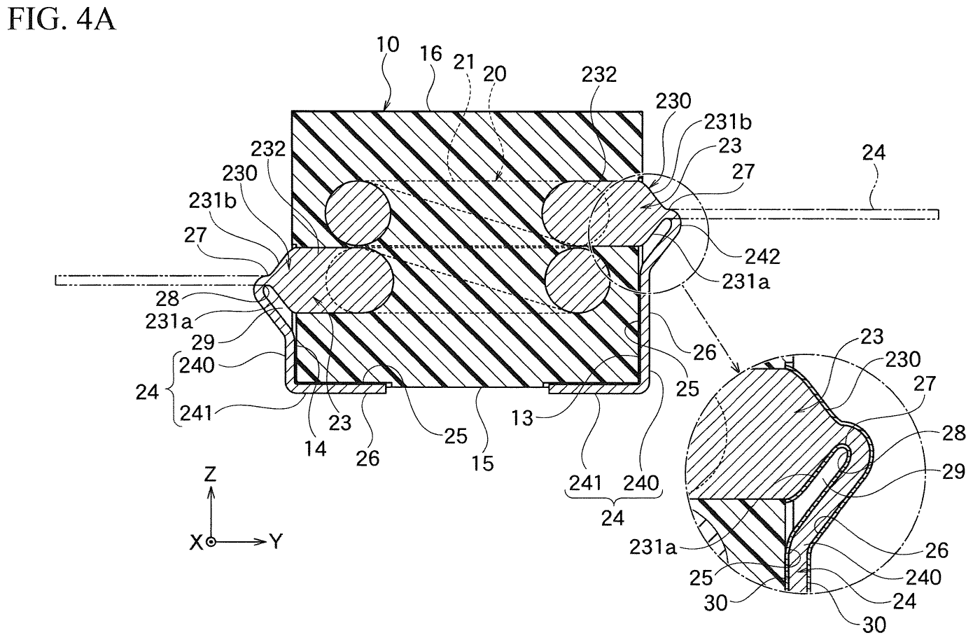

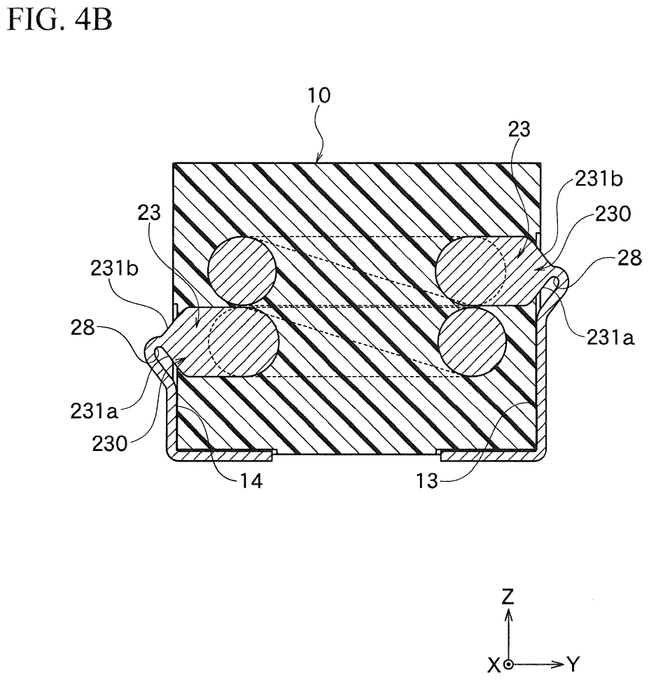

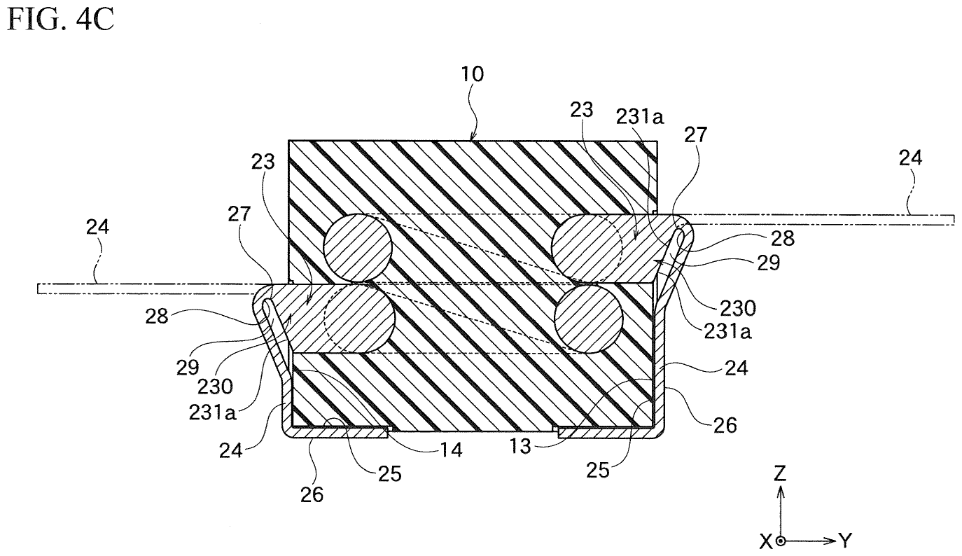

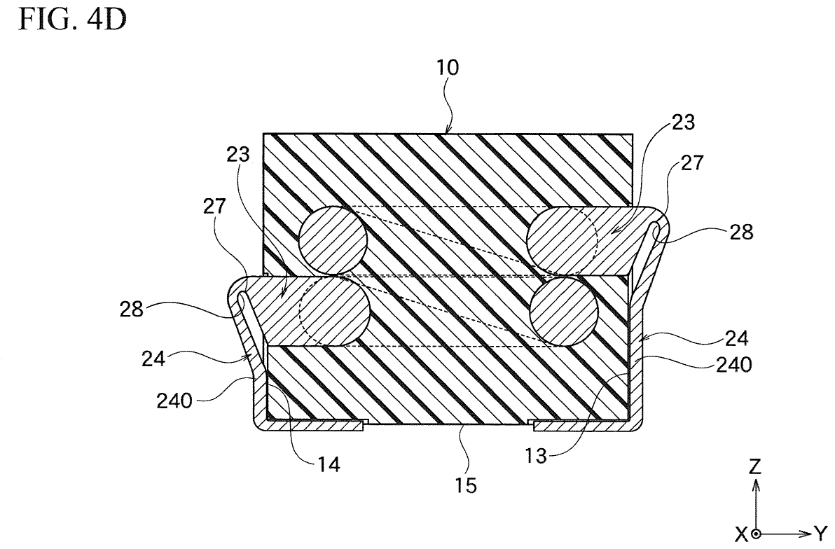

The winding portion 21 is an air-core coil and is disposed inside the core 10. In the winding portion 21, as shown in FIG. 2, the wire 20 is wound in a spiral shape with 1.5 turns. The winding axis direction of the winding portion 21 corresponds to the Z-axis direction. The number of layers in the winding axis direction (Z-axis direction) of the winding portion 21 is two (see FIG. 4A). However, the winding number of the wire 20 is not limited and may be 1.5 turns or more (e.g., 2.5 turns or 3.5 turns). The number of layers in the winding axis direction of the winding portion 21 may be two or four or more. In the winding portion 21, an insulating coating (insulating coating layer) is formed on the surface of the wire 20. When viewed from a direction perpendicular to the mounting surface 15 (Z-axis direction), the shape of the outer circumferential surface of the winding portion 21 is circular, but may be elliptical, or the like.

The leading portion 22a is led out from the second layer in the winding axis direction of the winding portion 21. The leading portion 22b is led out from the first layer in the winding axis direction of the winding portion 21 toward the opposite side to the leading portion 22a. Each of the leading portions 22a and 22b includes a base end portion 23 and a terminal portion 24. As shown in FIG. 4A, the leading portion 22a includes: an inner surface 25 facing the mounting surface 15 or the third side surface 13; and an outer surface 26 opposed to the inner surface 25. Also, the leading portion 22b includes: an inner surface 25 facing the mounting surface 15 or the fourth side surface 14; and an outer surface 26 opposed to the inner surface 25.

The base end portion 23 and the terminal portion 24 are formed by pressing (crushing) the leading portion 22a (22b). The terminal portion 24 is a portion of the leading portion 22a (22b) pressed into a flat shape. Meanwhile, the base end portion 23 is a portion where the thickness of the leading portion 22a (22b) (thickness between the inner surface 25 and the outer surface 26) gradually decreases from the winding portion 21 toward the terminal portion 24. In other words, unlike the terminal portion 24, the base end portion 23 is a portion where the leading portion 22a (22b) is not completely pressed. Hereinafter, the details of the base end portion 23 and the terminal portion 24 are described.

The base end portion 23 extends from the winding portion 21 toward the side surface (the third side surface 13 or the fourth side surface 14) of the core 10. One end of the base end portion 23 in its extending direction is continuous with the winding portion 21, and the other end of the base end portion 23 in its extending direction is continuous with the terminal portion 24.

The base end portion 23 includes an inclined portion 230 and a non-inclined portion 232. At least a part of the inclined portion 230 (in the example shown in FIG. 4A, the whole of the inclined portion 230) is exposed from the side surface (the third side 13 or the fourth side 14) of the core 10. In a cross section perpendicular to the mounting surface 15 and the third side 13 (i.e., YZ cross section), the thickness of the inclined portion 230 (thickness between the inner surface 25 and the outer surface 26) decreases toward a boundary portion 27 between the base end portion 23 and the terminal portion 24. In the present embodiment, the boundary portion 27 between the base end portion 23 and the terminal portion 24 is exposed from the core 10 and is not disposed inside the core 10.

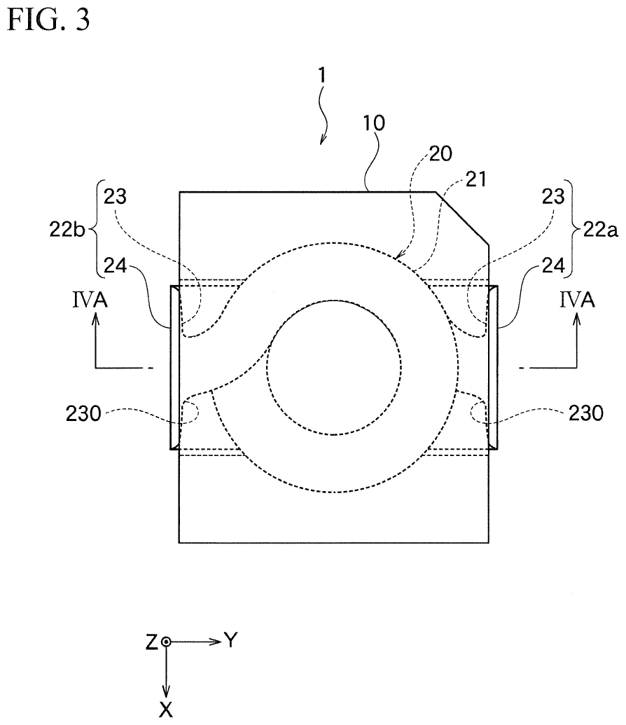

As shown in FIG. 3, when viewed from a direction perpendicular to the mounting surface 15 (i.e., Z-axis direction), the width of the inclined portion 230 in the X-axis direction increases toward the boundary portion 27 (FIG. 4A) between the base end portion 23 (inclined portion 230) and the terminal portion 24.

As shown in FIG. 4A, an inclined surface 231a is formed on the inner surface 25 of the inclined portion 230. The inclined surface 231a is inclined oppositely from the mounting surface 15 (toward the mounting opposition surface 16 or upward) toward the boundary portion 27 between the base end portion 23 and the terminal portion 24. The inclination angle of the inclined surface 231a with respect to the mounting surface 15 is not limited and is, for example, 10° or more and less than 90° or 30° or more and less than 90°.

An inclined surface 231b is formed on the outer surface 26 of the inclined portion 230. The inclined surface 231b is inclined to the mounting surface 15 (downward) toward the boundary portion 27 between the base end portion 23 and the terminal portion 24. The inclination angle of the inclined surface 231b with respect to the mounting opposition surface 16 is not limited and is, for example, 10° or more and less than 90° or 30° or more and less than 90°.

The non-inclined portion 232 is located between the winding portion 21 and the inclined portion 230. Unlike the inclined portion 230, the non-inclined portion 232 is a portion where the leading portion 22a (22b) is not pressed. Thus, the diameter of the wire 20 at the non-inclined portion 232 is equal to the diameter of the wire 20 at the winding portion 21.

However, the non-inclined portion 232 is not essential. The non-inclined portion 232 may be omitted from the base end portion 23, and the base end portion 23 may be formed only by the inclined portion 230. For example, the base end portion 23 may be inclined so that the thickness of the base end portion 23 (thickness between the inner surface 25 and the outer surface 26) decreases from the boundary portion between the winding portion 21 and the base end portion 23 toward the boundary portion 27 between the base end portion 23 and the terminal portion 24. In this case, one end of the inclined portion 230 in its extending direction is continuous with the winding portion 21, and the other end of the inclined portion 230 in its extending direction is continuous with the terminal portion 24.

In the inclined portion 230, the coating of the wire 20 is peeled off, and the inclined surfaces 231a and 231b are covered with no coating. However, the coating may remain on at least one of the inclined surfaces 231a and 231b. On the other hand, in the non-inclined portion 232, the coating of the wire 20 is not peeled off, and the surface of the non-inclined portion 232 is covered with the coating.

As shown in FIG. 4B, a part of the inclined portion 230 may be disposed inside the core 10, and a remaining part of the inclined portion 230 may be exposed from the side surface (the third side surface 13 or the fourth side surface 14) of the core 10. In the example shown in FIG. 4B, 50% or more of the inclined portion 230 is exposed from the side surface of the core 10, but less than 50% of the inclined portion 230 may be exposed from the side surface of the core 10. As shown in FIG. 4C, the inclined portion 230 is provided with the inclined surface 231a, but may not be provided with the inclined surface 231b (FIG. 4A). In the example shown in FIG. 4C, the outer surface 26 of the inclined portion 230 is not inclined and is parallel to the mounting surface 15.

As shown in FIG. 4D, in a cross section perpendicular to the mounting surface 15 and the third side surface 13 (i.e., YZ cross section), the thickness of the terminal portion 24 (side portion 240) may gradually decrease toward the boundary portion 27 between the base end portion 23 and the terminal portion 24. In the example shown in FIG. 4D, the thickness of the terminal portion 24 is smallest at the recess 28.

As shown in FIG. 4A, the terminal portion 24 is continuous with the base end portion 23 and extends along the side surface (the third side surface 13 or the fourth side surface 14) and the mounting surface 15 of the core 10. The thickness of the terminal portion 24 (thickness between the inner surface 25 and the outer surface 26) is substantially constant along the extending direction of the terminal portion 24. Note that, “substantially constant” means that the error in the thickness of the terminal portion 24 is within several percent to several tens of percent (this is not limited and is, for example, ±10%, ±5%, or ±3%). In the terminal portion 24, the coating of the wire 20 is peeled off, and the surface of the terminal portion 24 is not covered with the coating of the wire 20. As shown in FIG. 2, the terminal portion 24 has a flat shape and is formed wider in the X-axis direction than the diameter Φ of the wire 20.

The width W of the terminal portion 24 shown in FIG. 2 is not limited and is, for example, 1 to 10 mm. The ratio W/Φ of the width W of the terminal portion 24 in the X-axis direction to the diameter Φ of the wire 20 (the diameter of the wire 20 in the winding portion 21) is not limited and is, for example, 1<W/Φ≤10 or 2≤W/Φ≤8.

The thickness of the terminal portion 24 is not limited and is, for example, 0.05 to 0.5 mm. The ratio T/Φ of the thickness T of the terminal portion 24 to the diameter Φ of the wire 20 (the diameter of the wire 20 in the winding portion 21) is not limited and is, for example, 1/15≤T/Φ≤½ or 1/10≤T/Φ≤⅓.

As shown in FIG. 4A, the terminal portion 24 includes the side portion 240 and the mounting portion 241. The side portion 240 is continuous with the inclined portion 230 and extends along the side surface (the third side surface 13 or the fourth side surface 14) of the core 10. The side portion 240 includes a curved portion 242. In the present embodiment, in the vicinity of the boundary portion 27 between the base end portion 23 and the terminal portion 24, the terminal portion 24 is bent from the inclined portion 230 toward the side surface (the third side surface 13 or the fourth side surface 14) of the core 10. Thus, the curved portion 242 is formed at the bending position of the terminal portion 24.

The curved portion 242 is located at the upper end of the side portion 240 and is curved (bent) so as to protrude in a direction away from the side surface (the third side surface 13 or the fourth side surface 14) or the mounting surface 15 of the core 10. In the curved portion 242, both of the inner surface 25 and the outer surface 26 are curved, and the recess 28 is formed on the inner surface 25 of the curved portion 242. The curved portion 242 is curved from the boundary portion 27 between the base end portion 23 and the terminal portion 24 toward the side surface (the third side surface 13 or the fourth side surface 14) of the core 10. As shown in FIG. 4E, however, the curved portion 242 may be curved only in the vicinity of the boundary portion 27. In the example shown in FIG. 4E, the side portion 240 (the portion excluding the curved portion 242) extends in parallel to the side surface of the core 10.

Note that, in the present embodiment, “parallel” is not limited to being strictly parallel and also includes deviations of a few degrees (although not limited, for example, 3 degrees) or less from being strictly parallel, and “perpendicular” is not limited to being strictly perpendicular and also includes deviations of a few degrees (although not limited, for example, 3 degrees) or less from being strictly perpendicular.

As shown in FIG. 4A, a part of the side portion 240 is in contact with the side surface (the third side surface 13 or the fourth side surface 14) of the core 10. As shown in FIG. 4E, however, the side portion 240 may not be in contact with the side surface of the core 10, and a gap may be formed between the side portion 240 and the side surface of the core 10.

The mounting portion 241 is continuous with the side portion 240 and extends in a direction perpendicular to the side portion 240. The mounting portion 241 extends along the mounting surface 15. The mounting portion 241 is a portion connected to a mounting board (not shown) by a conductive bonding material (solder, conductive adhesive, etc.).

As shown in FIG. 1A, the mounting portion 241 of the leading portion 22a is disposed in the second recess 18a formed on the mounting surface 15. Also, the mounting portion 241 of the leading portion 22b is disposed in the second recess 18b formed on the mounting surface 15. Also, the side portion 240 of the leading portion 22a is disposed in the first recess 17a formed on the third side surface 13. The side portion 240 of the leading portion 22b is disposed in the first recess 17b formed on the fourth side surface 14.

As shown in FIG. 4A, a plating layer 30 is formed on the inner surface 25 and the outer surface 26 of the leading portion 22a. Although not illustrated in detail, the plating layer 30 is formed on the inner surface 25 and the outer surface 26 of the leading portion 22b. In particular, since the plating layer 30 is formed on the outer surface 26, the adhesion of a bonding material (e.g., solder or conductive adhesive) to the outer surface 26 is improved at the time of mounting the coil device 1. The plating layer 30 may be a single layer or multiple layers. The plating layer 30 is not limited and is, for example, Cu plating, Ni plating, Sn plating, Ni—Sn plating, Cu—Ni—Sn plating, Ni—Au plating, Au plating, or Sn—Pb plating (solder plating).

The plating layer 30 is formed on a portion of the base end portion 23 exposed from the core 10, namely, on the inclined portion 230. The plating layer 30 is formed on both of the inner surface 25 (inclined surface 231a) and the outer surface 26 (inclined surface 231b) of the inclined portion 230, but may be formed on either the inner surface 25 or the outer surface 26. For example, the plating layer 30 may not be formed on the inner surface 25 of the inclined portion 230, and the inner surface 25 of the inclined portion 230 may be covered with the coating of the wire 20.

The plating layer 30 is also formed on both of the inner surface 25 and the outer surface 26 of the terminal portion 24. However, the plating layer 30 may not be formed on the inner surface 25 of the terminal portion 24 (the side portion 240 or the mounting portion 241) and may be formed on the outer surface 26 of the terminal portion 24 (the side portion 240 or the mounting portion 241). In this case, the inner surface 25 of the terminal portion 24 (the side portion 240 or the mounting portion 241) may be covered with the coating of the wire 20.

The plating layer 30 is formed on both of the side portion 240 and the mounting portion 241 of the terminal portion 24. However, the plating layer 30 may not be formed on the side portion 240 and may be formed on the mounting portion 241. In this case, the side portion 240 may be covered with the coating of the wire 20.

The recess 28 is formed in the vicinity of the boundary portion 27 between the base end portion 23 and the terminal portion 24 (see the enlarged view in FIG. 4A). The recess 28 is formed on the inner surface 25 of the leading portion 22a (22b). In the vicinity of the boundary portion 27 between the base end portion 23 and the terminal portion 24, the inner surface 25 of the leading portion 22a (22b) is curved or bent along the recess 28. The recess 28 is recessed toward the opposite side to the mounting surface 15 (toward the mounting opposition surface 16 or upward). In the example shown in FIG. 4A, the recess 28 is recessed toward the opposite side to the mounting surface 15 and in a direction away from the side surface (the third side surface 13 or the fourth side surface 14) of the core 10.

The recess 28 is formed by the inclined surface 231a of the base end portion 23 (inclined portion 230) and the inner surface 25 of the terminal portion 24 (side portion 240). That is, a part of the recess 28 is formed along the inclined surface 231a, and a remaining part of the recess 28 is formed along the inner surface 25 of the terminal portion 24 (side portion 240). In particular, in the vicinity of the boundary portion 27 between the base end portion 23 and the terminal portion 24, the recess 28 is formed along the inclined surface 231a and the inner surface 25 of the curved portion 242 (i.e., the curved surface of the curved portion 242). The bottom of the recess 28 is formed in the vicinity of the boundary portion 27 between the base end portion 23 and the terminal portion 24.

At least a part (in the present embodiment, the whole) of the recess 28 is exposed from the core 10. However, a part of the recess 28 may be exposed from the core 10, and a remaining part of the recess 28 may be disposed inside the core 10. For example, as shown in FIG. 4B, when a part of the inclined portion 230 is disposed inside the core 10, a part of the recess 28 is exposed from the core 10, and a remaining part of the recess 28 is disposed inside the core 10. As shown in FIG. 4A, the bottom of the recess 28 is located at a position located on the outer side in the Y-axis direction from the side surface (the third side 13 or the fourth side 14) of the core 10.

The plating layer 30 is formed on the recess 28. That is, in the recess 28, the plating layer 30 is formed on the inner surface 25 (inclined surface 231a) of the inclined portion 230. Also, in the recess 28, the plating layer 30 is formed on the inner surface 25 of the terminal portion 24 (side portion 240). However, the plating layer 30 may not be formed on the recess 28. In this case, in the recess 28, the inclined surface 231a and the inner surface 25 of the terminal portion 24 may be covered with the coating of the wire 20.

A space 29 is formed inside the recess 28. The space 29 is surrounded by the inclined surface 231a, the inner surface 25 of the terminal portion 24 (side portion 240), and the side surface (the third side surface 13 or the fourth side surface 14) of the core 10. In a cross section perpendicular to the mounting surface 15 and the third side surface 13 (i.e., YZ cross section), the space 29 extends from the bottom of the recess 28 toward the side surface (the third side surface 13 or the fourth side surface 14) of the core 10. As shown in FIG. 4E, however, the space 29 may extend toward the mounting surface 15 along the side surface (the third side surface 13 or the fourth side surface 14) of the core 10.

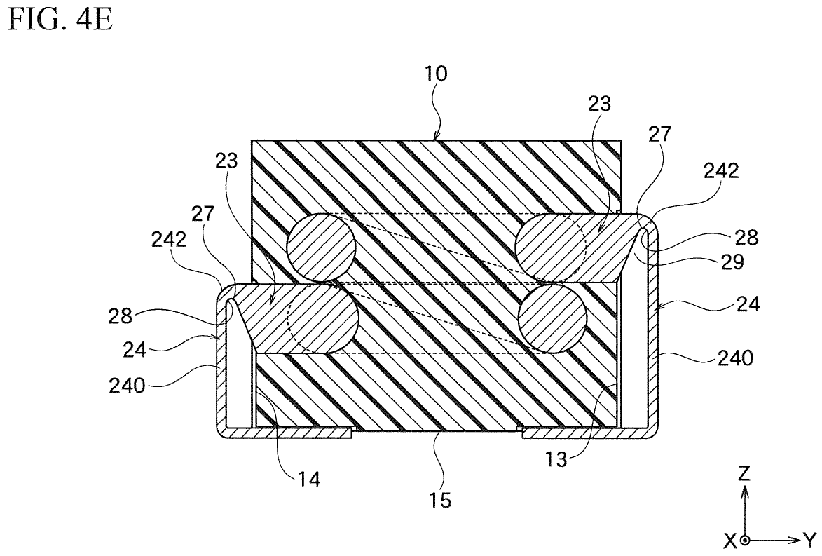

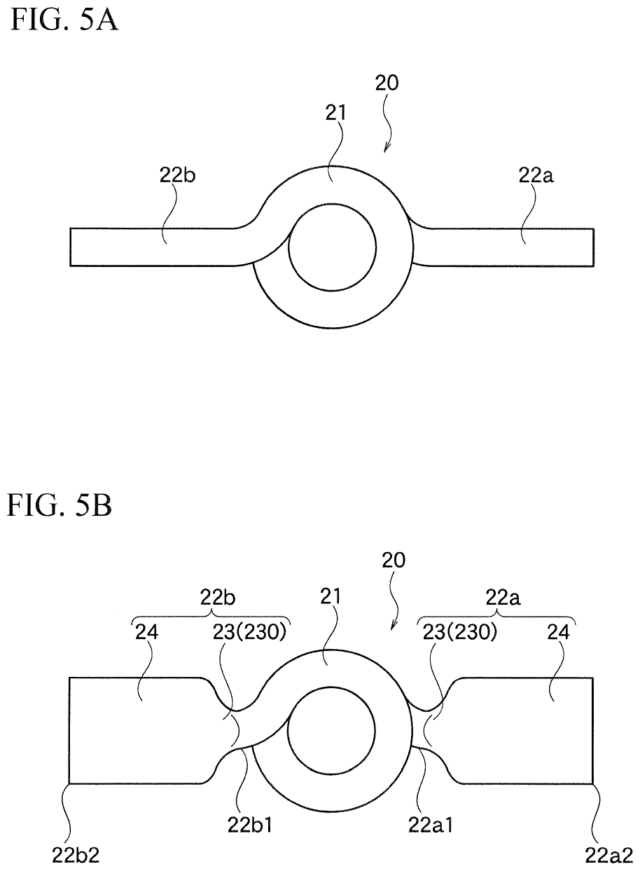

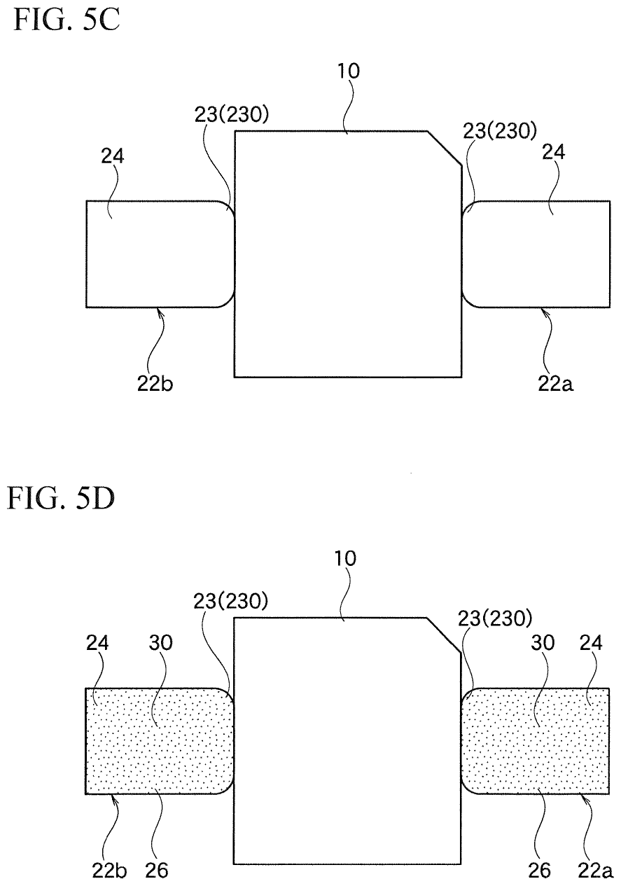

Next, a method of manufacturing a coil device 1 shown in FIG. 1B is described with reference to FIG. 5A to FIG. 5D, etc. First, as shown in FIG. 5A, prepared is a wire 20 including a winding portion 21 and leading portions 22a and 22b led out from the winding portion 21. The wire 20 is a round wire, but may be a rectangular wire. The winding portion 21 is an air-core coil, and the leading portions 22a and 22b are led out from the winding portion 21 toward the opposite directions.

Next, as shown in FIG. 5B, the leading portion 22a is pressed so as to form a flat terminal portion 24 and an inclined portion 230 (see FIG. 4A) in the leading portion 22a. The inclined portion 230 has a thickness (thickness between an inner surface 25 and an outer surface 26) gradually decreasing from the winding portion 21 toward the terminal portion 24. The range in which the leading portion 22a is pressed is, for example, from a boundary portion 22a1 between the winding portion 21 and the leading portion 22a to a tip portion 22a2 of the leading portion 22a. As a result, a base end portion 23 including the inclined portion 230 shown in FIG. 4A is formed in the vicinity of the boundary portion 22a1 between the winding portion 21 and the leading portion 22a. Also, the terminal portion 24 is formed on the tip side of the leading portion 22a from the base end portion 23.

Also, as shown in FIG. 5B, the leading portion 22b is pressed so as to form a flat terminal portion 24 and an inclined portion 230 (see FIG. 4A) in the leading portion 22b. The inclined portion 230 has a thickness gradually decreasing from the winding portion 21 toward the terminal portion 24. The range in which the leading portion 22b is pressed is, for example, from a boundary portion 22b1 between the winding portion 21 and the leading portion 22b to a tip portion 22b2 of the leading portion 22b. As a result, a base end portion 23 including the inclined portion 230 shown in FIG. 4A is formed in the vicinity of the boundary portion 22b1 between the winding portion 21 and the leading portion 22b. Also, the terminal portion 24 is formed on the tip side of the leading portion 22b from the base end portion 23.

Next, the wire 20 is placed in a cavity of a mold (not shown), and the cavity is filled with a core material containing a magnetic material and a resin. At this time, the core material is filled into the cavity so that: the winding portion 21 is embedded in the core material; at least a part of the base end portion 23 is exposed from the core material; and the terminal portion 24 is exposed from the core material. Next, the core material filled in the cavity is compressed and hardened at a predetermined mold temperature for a predetermined time so as to form a core 10 shown in FIG. 5C.

Next, for example, the terminal portions 24 exposed from the core 10 are irradiated with a laser so as to peel off the coating on the surfaces of the terminal portions 24. Also, for example, the base end portions 23 (inclined portions 230) exposed from the core 10 are irradiated with a laser so as to peel off the coating on the surfaces of the base end portions 23.

Next, as shown in FIG. 5D, a plating layer 30 is formed on the terminal portions 24 exposed from the core 10. In the present embodiment, the plating layer 30 is formed on inner surfaces 25 (FIG. 4A) and n outer surfaces 26 (FIG. 4A) of the terminal portions 24, but the plating layer 30 may be formed only on the outer surfaces 26 of the terminal portions 24. Also, the plating layer 30 is formed on inner surfaces 25 (inclined surfaces 231a) and outer surfaces 26 (inclined surfaces 231b) of the base end portions 23 (inclined portions 230) exposed from the core 10. In the present embodiment, the plating layer 30 is formed on the inner surfaces 25 and the outer surfaces 26 of the base end portions 23, but the plating layer 30 may be formed only on the outer surfaces 26 of the base end portions 23. The plating layer 30 is not limited and is, for example, Sn—Pb plating (solder plating). The method of forming the plating layer 30 is not limited and is, for example, electroless plating, electrolytic plating, or dipping. Note that, the step of forming the plating layer 30 on the terminal portions 24 and/or the base end portions 23 may be performed before the core 10 is molded (before the step shown in FIG. 5C).

Next, as shown in FIG. 4A, in the vicinity of the boundary portion 27 between the base end portion 23 (inclined portion 230) and the terminal portion 24, the terminal portion 24 of the leading portion 22a is bent from the base end portion 23 (inclined portion 230) toward a third side surface 13 of the core 10 (see the view indicated by the two-dot chain line in FIG. 4A). As a result, the side portion 240 of the terminal portion 24 is disposed along the third side surface 13. Also, in the vicinity of the boundary portion 27 between the base end portion 23 (inclined portion 230) and the terminal portion 24, the terminal portion 24 of the leading portion 22b is bent from the base end portion 23 (inclined portion 230) toward a fourth side surface 14 of the core 10. As a result, the side portion 240 of the terminal portion 24 is disposed along the fourth side surface 14.

Next, the tip of the terminal portion 24 disposed along the third side surface 13 is bent toward a mounting surface 15 of the core 10. As a result, a mounting portion 241 of the terminal portion 24 is disposed along the mounting surface 15. Also, the tip of the terminal portion 24 disposed along the fourth side surface 14 is bent toward a mounting surface 15 of the core 10. As a result, a mounting portion 241 of the terminal portion 24 is disposed along the mounting surface 15. Accordingly, the coil device 1 can be manufactured.

In the manufacture of the coil device 1, the plating layer 30 of the terminal portion 24 may melt due to, for example, the heat of reflow. In the coil device 1 of the present embodiment, as shown in FIG. 4A, the recess 28 recessed toward the opposite side to the mounting surface 15 is formed in the vicinity of the boundary portion 27 between the base end portion 23 and the terminal portion 24. Thus, the molten plating layer 30 (hereinafter, referred to as “molten plating”) is likely to accumulate in the recess 28 and is less likely to wet up to the winding portion 21 via the terminal portion 24 and the base end portion 23. Also, the creeping distance from the terminal portion 24 to the winding portion 21 is increased by the recess 28 formed in the leading portion 22a, and the molten plating is less likely to wet up to the winding portion 21 via the terminal portion 24 and the base end portion 23. Thus, the molten plating is less likely to adhere to the winding portion 21, and the occurrence of short-circuit defects can be prevented.

When the coil device 1 is mounted, a bonding material (solder, conductive adhesive, etc.) may wet up via the terminal portion 24 at the time of connecting the terminal portion 24 to a mounting board (not shown) with the bonding material. Even in such a case, the bonding material is likely to accumulate in the recess 28 and is thus less like to wet up to the winding portion 21 via the terminal portion 24 and the base end portion 23. Since the creeping distance from the terminal portion 24 to the winding portion 21 is increased by the recess 28 formed in the leading portion 22a, the bonding material is less likely to wet up to the winding portion 21 via the terminal portion 24 and the base end portion 23. Thus, the bonding material is less likely to adhere to the winding portion 21, and in this respect, the occurrence of short circuit defects can also be prevented.

At least a part (in the present embodiment, the whole) of the recess 28 is exposed from the core 10. Thus, when the coil device 1 is mounted, a molten plating or a bonding material is likely to accumulate in the recess 28 on the outside of the core 10 and is less likely to enter the core 10. This makes it possible to effectively prevent the molten plating or the bonding material from wetting up to the winding portion 21.

The leading portion 22a includes the inner surface 25 facing the mounting surface 15 or the third side surface 13 and the outer surface 26 opposed to the inner surface 25. Then, the recess 28 is formed on the inner surface 25. Thus, the recess 28 is curved (bent) toward the opposite side to the mounting surface 15. This makes it easier for a molten plating or a bonding material to accumulate in the recess 28 and makes it possible to effectively prevent the molten plating or the bonding material from wetting up to the winding portion 21.

The base end portion 23 includes the inclined portion 230, and at least a part (in the present embodiment, the whole) of the inclined portion 230 is exposed from the core 10. Then, in a cross section perpendicular to the mounting surface 15 and the third side surface 13 (i.e., YZ cross section), the thickness of the inclined portion 230 decreases toward the boundary portion 27. Thus, at the time of manufacturing the coil device 1, the terminal portion 24 is easily bent from the inclined portion 230 in the vicinity of the boundary portion 27 between the inclined portion 230 and the terminal portion 24. This makes it possible to easily form the recess 28 recessed toward the opposite side to the mounting surface 15 in the vicinity of the boundary portion 27 between the inclined portion 230 and the terminal portion 24.

The inclined portion 230 includes the inclined surface 231a inclined oppositely from the mounting surface 15 toward the boundary portion 27. Thus, at the time of manufacturing the coil device 1, the recess 28 is formed along the inclined surface 231a by bending the terminal portion 24 from the inclined portion 230 in the vicinity of the boundary portion 27 between the inclined portion 230 and the terminal portion 24. This makes it possible to easily form the recess 28 recessed toward the opposite side to the mounting surface 15 in the vicinity of the boundary portion 27 between the inclined portion 230 and the terminal portion 24. Also, the recess 28 can be formed with a depth corresponding to the inclination angle of the inclined surface 231a. Thus, the amount of molten plating or bonding material stored in the recess 28 can be adjusted according to the depth of the recess 28.

A part of the recess 28 is formed along the inclined surface 231a, and a remaining part of the recess 28 is formed along the inner surface 25 of the terminal portion 24. Thus, the recess 28 recessed toward the opposite side to the mounting surface 15 can be formed so that the bottom of the recess 28 is located in the vicinity of the boundary portion 27 between the inclined portion 230 and the terminal portion 24. This makes it easier for the molten plating or bonding material to accumulate in the recess 28 and makes it possible to effectively prevent the molten plating or bonding material from wetting up to the winding portion 21.

The plating layer 30 is formed at least on the inner surface 25 in the recess 28. Thus, the molten plating or bonding material flown into the recess 28 is likely to remain in the recess 28 and is less likely to flow out of the recess 28 toward the winding portion 21. This makes it possible to effectively prevent the molten plating or bonding material from wetting up to the wound portion 21.

As shown in FIG. 4D, in a cross section perpendicular to the mounting surface 15 and the third side surface 13 (i.e., YZ cross section), the thickness of the leading portion 22a (22b) is smallest at the recess 28. Thus, the recess 28 can be formed deeper toward the opposite side to the mounting surface 15, and a molten plating or bonding material can be easily stored in the recess 28.

As shown in FIG. 4A, the terminal portion 24 includes the side portion 240 extending along the third side surface 13 and the mounting portion 241 extending along the mounting surface 15. Thus, the mounting portion 241 can be connected to a mounting board by a bonding material. Also, a fillet of the bonding material can be formed on the side portion 240, and the mounting strength of the coil device 1 is improved.

In the method of manufacturing the coil device 1 according to the present embodiment, the terminal portion 24 is bent from the inclined portion 230 toward the core 10 in the vicinity of the boundary portion 27 between the inclined portion 230 and the terminal portion 24. Thus, the recess 28 recessed toward the opposite side to the mounting surface 15 can be formed along the inclined portion 230 and the terminal portion 24 in the vicinity of the boundary portion 27 between the inclined portion 230 and the terminal portion 24. Thus, at the time of manufacturing the coil device 1, the molten plating or bonding material is likely to accumulate in the recess 28 and can be prevented from wetting up to the winding portion 21.

The present disclosure is not limited to the above-described embodiment and may variously be modified within the scope of the present disclosure.

In the above-described embodiment, an application example of the present disclosure to an inductor is described, but the present disclosure may be applied to other coil devices.

The inclined portion 230 shown in FIG. 4C to FIG. 4E includes one inclined surface 231a, but may include two inclined surfaces 231a and 231b (see FIG. 4A). The inclined portion 230 shown in FIG. 4C to FIG. 4E is entirely exposed from the core 10, but may be partially exposed from the core 10 (see FIG. 4B). That is, a part of the inclined portion 230 shown in FIG. 4C to FIG. 4E may be disposed inside the core 10.

### DESCRIPTION OF THE REFERENCE NUMERICAL

1 . . . coil device
10 . . . core

11 . . . first side surface

12 . . . second side surface

13 . . . third side surface

14 . . . fourth side surface

15 . . . mounting surface

16 . . . mounting opposition surface

17a, 17b . . . first recess

18a, 18b . . . second recess

19 . . . chamfered portion

20 . . . wire

21 . . . winding portion

22a, 22b . . . leading portion

22a2, 22b2 . . . tip portion

23 . . . base end portion

230 . . . inclined portion

231a, 231b . . . inclined surface

232 . . . non-inclined surface

24 . . . terminal portion

240 . . . side portion

241 . . . mounting portion

242 . . . curved portion

25 . . . inner surface

26 . . . outer surface

27, 22a1, 22b1 . . . boundary portion

28 . . . recess

29 . . . space

30 . . . plating layer

What is claimed is:

1. A coil device comprising:
a core containing a magnetic material and including a mounting surface and a side surface extending in a direction perpendicular to the mounting surface; and
a wire including a winding portion disposed inside the core and a leading portion led out from the winding portion,
wherein
the leading portion includes:
a base end portion extending from the winding portion toward the side surface; and
a flat terminal portion continuing to the base end portion and extending along at least the side surface,
a plating layer is formed on the terminal portion, and
a recess recessed toward the opposite side to the mounting surface is formed in the vicinity of a boundary portion between the base end portion and the terminal portion.

2. The coil device according to claim 1, wherein at least a part of the recess is exposed from the core.

3. The coil device according to claim 1, wherein
the leading portion includes:
an inner surface facing the mounting surface or the side surface; and
an outer surface opposed to the inner surface, and
the recess is formed on the inner surface.

4. The coil device according to claim 1, wherein
the base end portion includes an inclined portion,
at least a part of the inclined portion is exposed from the core, and
a thickness of the inclined portion decreases toward the boundary portion in a cross section perpendicular to the mounting surface and the side surface.

5. The coil device according to claim 4, wherein the inclined portion includes an inclined surface inclined oppositely from the mounting surface toward the boundary portion.

6. The coil device according to claim 5, wherein
the leading portion includes:
an inner surface facing the mounting surface or the side surface; and
an outer surface opposed to the inner surface,
a part of the recess is formed along the inclined surface, and
a remaining part of the recess is formed along the inner surface of the terminal portion.

7. The coil device according to claim 1, wherein
the leading portion includes:
an inner surface facing the mounting surface or the side surface; and
an outer surface opposed to the inner surface, and
the plating layer is formed at least on the inner surface in the recess.

8. The coil device according to claim 1, wherein a thickness of the leading portion is smallest at the recess in a cross section perpendicular to the mounting surface and the side surface.

9. The coil device according to claim 1, wherein the terminal portion includes:
a side portion extending along the side surface; and
a mounting portion extending along the mounting surface.

10. A method of manufacturing a coil device, comprising the steps of:
preparing a wire including a winding portion and a leading portion led out from the winding portion;
forming a flat terminal portion and an inclined portion by pressing the leading portion, the inclined portion being having a thickness decreasing from the winding portion toward the terminal portion;
placing the wire in a cavity of a mold and filling the cavity with a core material containing a magnetic material and a resin so that the winding portion is embedded;
forming a core by compressing the core material;
forming a plating layer at least on the terminal portion; and
bending the terminal portion from the inclined portion toward the core in the vicinity of a boundary portion between the inclined portion and the terminal portion.
